(19) United States
(12) Patent Application Publication
(10) Pub. No.: US 2013/0116824 A1
(43) Pub. Date: May 9, 2013

(54) ROBOTIC MANIPULATOR

(71) Applicant: Mark E. Rosheim, St. Paul, MN (US)

(72) Inventor: Mark E. Rosheim, St. Paul, MN (US)

(73) Assignee: ROSS-HIME DESIGNS, INC., St. Paul, MN (US)

(21) Appl. No.: 13/808,656

(22) PCT Filed: Jul. 8, 2011
(86) PCT No.: PCT/US2011/043382

§ 371 Date: Jan. 7, 2013

Related U.S. Application Data
(60) Provisional application No. 61/399,151, filed on Jul. 8, 2010.

(51) Int. Cl. B25J 9/16

(52) U.S. Cl. CPC B25J 9/16
USPC 700/258

(57) ABSTRACT

A mechanical manipulator (1) selectively positions an output structure (2, 20). The mechanical manipulator (1) includes a base assembly (3), a holder base (4) attached to the base assembly (3), a holder (5, 25) attached to the holder base (4) and being rotatable by a holder rotation motor (9), a first resolver (7) mounted to measure rotational movement of the holder (5, 25), an output structure rotation motor (13) configured to rotate the output structure (2, 20), and a second resolver (11) mounted to measure rotational movement of the output structure (2, 20).

This invention was made with government support under contract no. W9113M-09-C-0013 awarded by the United States Army Space & Missile Defense Command. The government has certain rights in the invention.

### BACKGROUND

Increasing use of precision directional electromagnetic radiation sensors sensitive in various frequency or wavelength ranges has added to the need for mechanical manipulators that can point objects, or workpieces, mounted thereon, such as those sensors, accurately and repeatedly anywhere in a desired workspace. Many kinds of these sensors must be pointable over many different circular arc ranges all exceeding 60°, and be capable of doing so at large angular position change rates. Singularities in the dynamics of such manipulators, or loss of a degree-of-freedom in the workspace, due both to conditions in the physical structure or in control software used in the control system provided therefor, often impede the performance of mechanical manipulators in reaching these goals.

Many uses of these require a highly precise but limited range of motion for the manipulator in providing various desired pointings of objects mounted thereon. One such manipulator that has been used for these purposes is provided by gimbals supporting an object for pointing such as a sensor. In the past, such pointing gimbals have had a gimbal ring arrangement driven by a pair of motors. Their use requires providing therewith flexible wiring or slip-rings, or both, to supply electrical power to the mounted object, and to provide position and rate information to at least one of the drive motors. These slip-rings, or other forms of supplying electrical power and communicating information through or around objects rotating relative to each other, often result in reliability problems due to mechanical wear, aging through corrosion, and other environmental factors.

Another performance requirement is that the mounted object such as a sensor be as isolated as possible from shock and vibration which is always present in uses of such manipulators such as when a missile in which a sensor is mounted on such a manipulator is being handled, carried on a moving platform, or propelled in flight. Typically in the past, gimbals supporting an object for pointing such as a sensor were mounted directly to structural walls in the missile and so were directly subjected to the accompanying shocks and vibrations. As a result, elaborate and costly means have been designed for gimbal mounted sensors to attempt to isolate them from such shocks and vibrations otherwise transmitted thereto by the gimbals. However, this adds to the cost and complexity of the device.

In many instances, and in particular, in airborne systems such as missiles, it is very advantageous for manipulators used for pointing sensors therein toward desired locations to be very compact. Not only do such manipulators need to be compact in mechanical extent themselves but also must manipulate the sensor mounted thereon in a very compact workspace. The sensors being manipulated may be relatively large compared to the work envelope within which they are manipulated. This necessitates a robotic manipulator that has relatively thin cross-sections when viewed from certain directions that together permit operation in a confined space while at the same time manipulating a relatively bulky sensor.

One reason for this compact space limiting of the sensor motion becoming critical is due to the geometry required for the missile nose cone that is necessary for it to meet its aerodynamic performance specifications. The nose cone, for example, may incorporate a hemispherical transparent lens defining much of the workspace that, as indicated above, requires the motion of the sensor to track the geometry of the interior surface of that lens so as to leave a consistently small separation distance between that lens interior surface and the sensor structure, and such that the sensor pointing or sensing axis is maintained in directions normal to that surface.

Because of these very limited spatial confines, even some of the more recently developed mechanical manipulators for pointing workpieces such as sensors capable of operating in such confines can be susceptible to unacceptable motion in response to vibration and shock affecting their mounts. Resorting to space saving configurations and reducing dimensions of structural members to reduce spatial volume of these manipulators can lead to unwanted structural motion in such conditions. Thus, there is a desire for an improved pointing mechanical manipulator especially for use with precise direction sensors in limited confines subject to substantial vibration and mechanical shock during operations.

### SUMMARY

According to an aspect of the present invention, a mechanical manipulator is provided to selectively position an output structure. The mechanical manipulator includes a base assembly, a holder base attached to the base assembly, a holder attached to the holder base and being rotatable by a holder rotation motor, a first resolver mounted to measure rotational movement of the holder, an output structure rotation motor configured to rotate the output structure, and a second resolver mounted to measure rotational movement of the output structure.

### BRIEF DESCRIPTION OF THE DRAWINGS

FIG. 1 is an elevated perspective view of a mechanical manipulator embodying the present invention,

FIG. 2 is another perspective view of the manipulator shown in FIG. 1,

FIG. 3 is a bottom view of the manipulator shown in FIG. 1,

FIG. 4 is a top view of the manipulator shown in FIG. 1,

FIG. 5 is a side cross section view of the manipulator shown in FIG. 1 as indicated in FIG. 4,

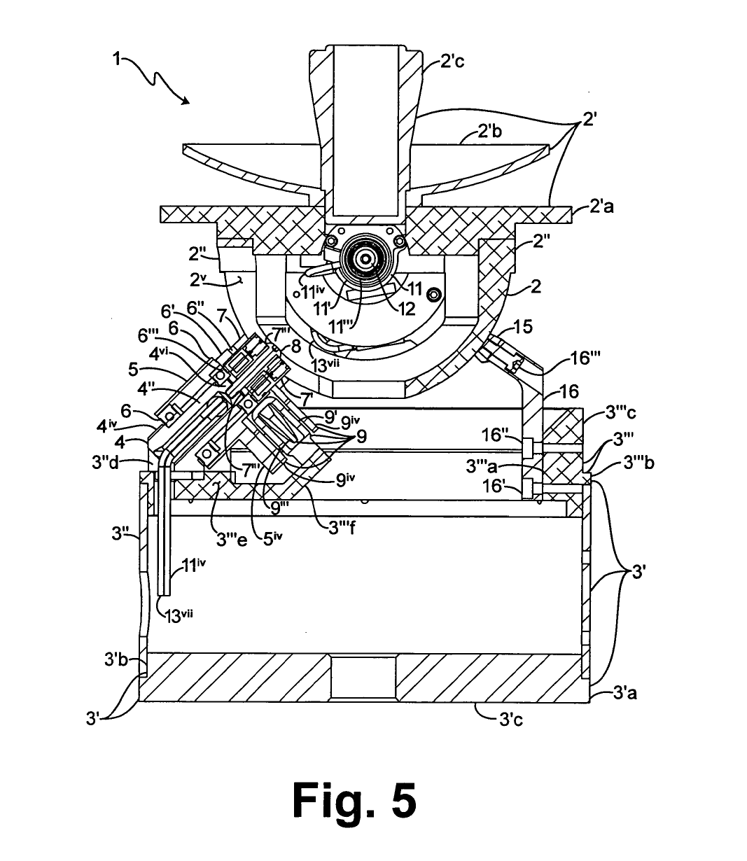

FIG. 6 is another side cross section view of the manipulator shown in FIG. 1 as indicated in FIG. 4,

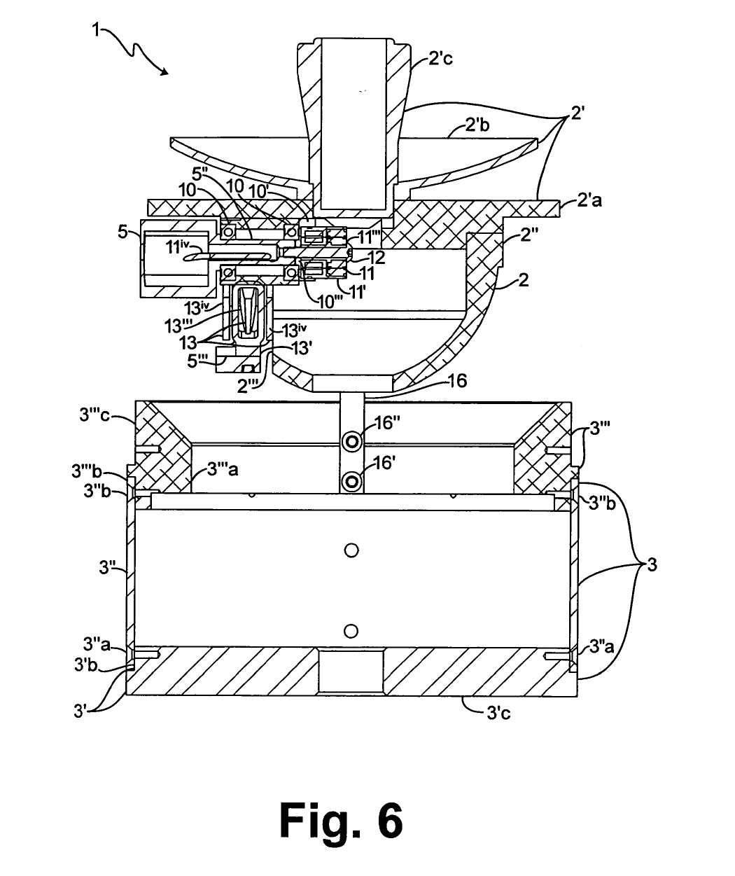

FIG. 7 is a frontal elevation view of the manipulator shown in FIG. 1,

FIG. 8 is an exploded view of the manipulator shown in FIG. 1,

FIG. 9 is a side elevation view of the manipulator shown in FIG. 7,

FIG. 10 is again the side elevation view of the manipulator shown in FIG. 1,

FIG. 11 is a frontal perspective cross section view of the manipulator shown in FIG. 1 as indicated in FIG. 10,

FIG. 12 is a side elevation view of a mechanical manipulator in another embodiment of the present invention,

FIG. 13 is a frontal perspective cross section view of the manipulator shown in FIG. 12 as indicated in that figure, and

FIG. 14 is an exploded view of the manipulator shown in FIG. 1

### DETAILED DESCRIPTION

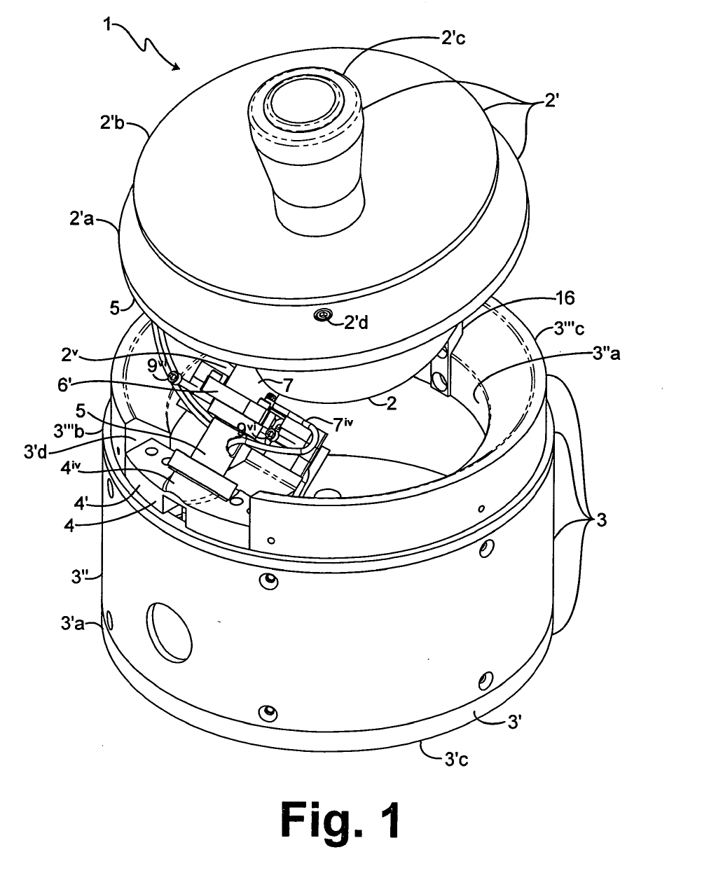

The object positioning arrangement, or manipulator, 1, shown in the elevated perspective view of FIG. 1, allows an object or workpiece to be rotated to various pointings by that manipulator about a single center point of rotation that is coincident with the approximate center of a plane parallel to the flat or opening side of an output structure, 2, that generally follows the shape of a hemispherical shell but with shape modifications. A workpiece, 2′, is mounted across this opening of output structure 2. Thus, workpiece 2′, depending on its size, may be mounted above or across from the center point of rotation of output structure 2, or even below that point in the interior of output structure 2 if that interior is open so as to be able to accommodate that workpiece. Alternatively, output structure 2 and workpiece object 2′ may be to some extent structurally integrated through having some shared structural members.

The center point of rotation of output structure 2 is the intersection of two axes about one of which output structure 2 is rotatably connected to the end of a supporting and manipulating curved support bar arrangement, possibly a hollow bar, and with that axis extending through that bar end. The other axis about which output structure 2 is rotated, along with the supporting and manipulating curved support bar arrangement, extends through the other end of that arrangement which is rotatably connected there to a curved support bar base so that this axis extends through that base. This configuration is particularly advantageous when manipulating workpiece object 2′, such as a sensor or multiple sensors, which, when placed in motion by manipulator 1, must follow closely the interior surface of a lens or radome while requiring minimum lengths of wire, tubing, or fiber optic harnesses for conveying power and signals to or from that workpiece object, or both. Also, the workpiece object, again such as a sensor or multiple sensors, may need to undergo those motions in a very compact workspace without mechanically interfering with housing or other structures positioned in the vicinity thereof. As shown in the example given here, workpiece object 2′ represents a triple sensor arrangement including a radar antenna, 2′a, an infrared reflector, 2′b, and a semiactive laser, with the latter along with corresponding electromagnetic radiation detectors, provided in an electromagnetic devices housing, 2′c. Workpiece object 2′ is shown affixed to output structure 2 by bolts, 2′d, extending through the representation of radar antenna 2′a.

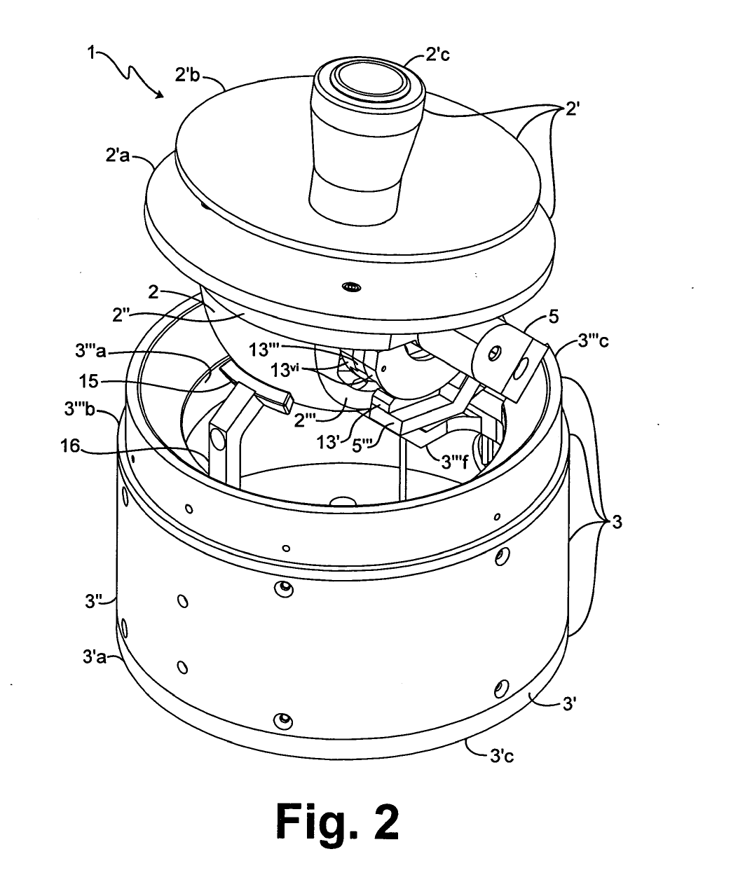

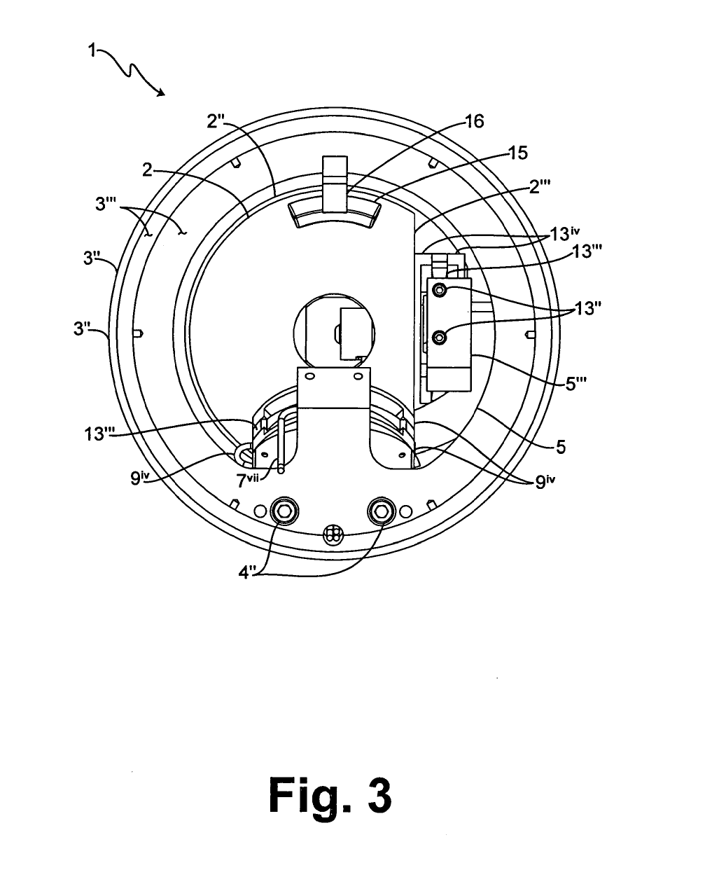

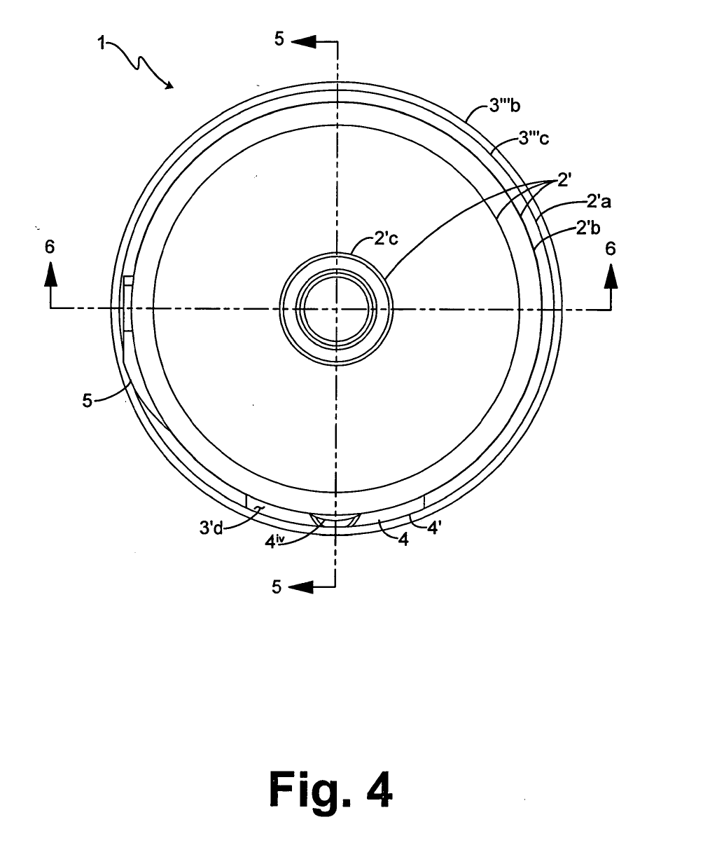

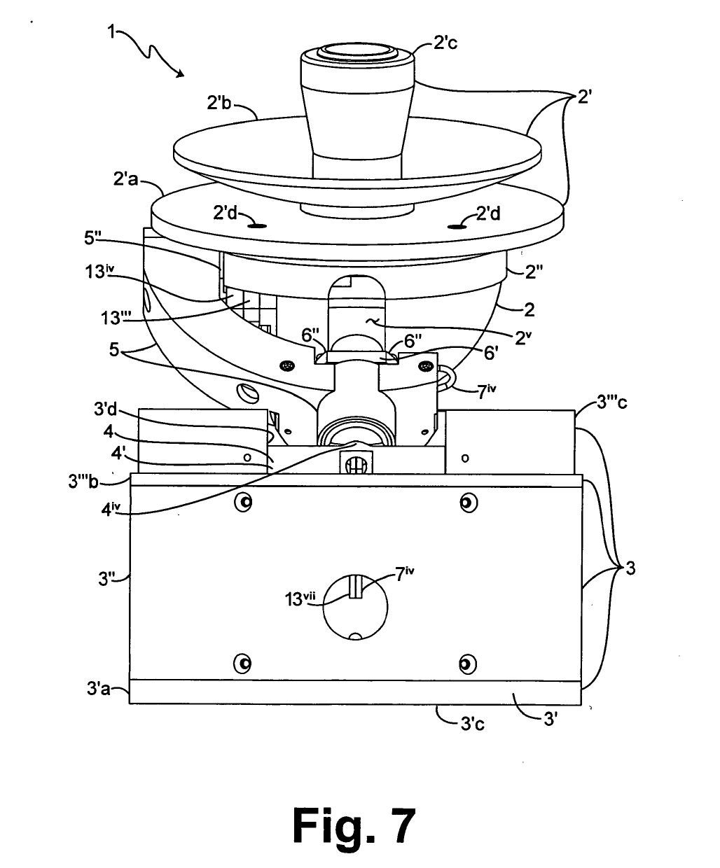

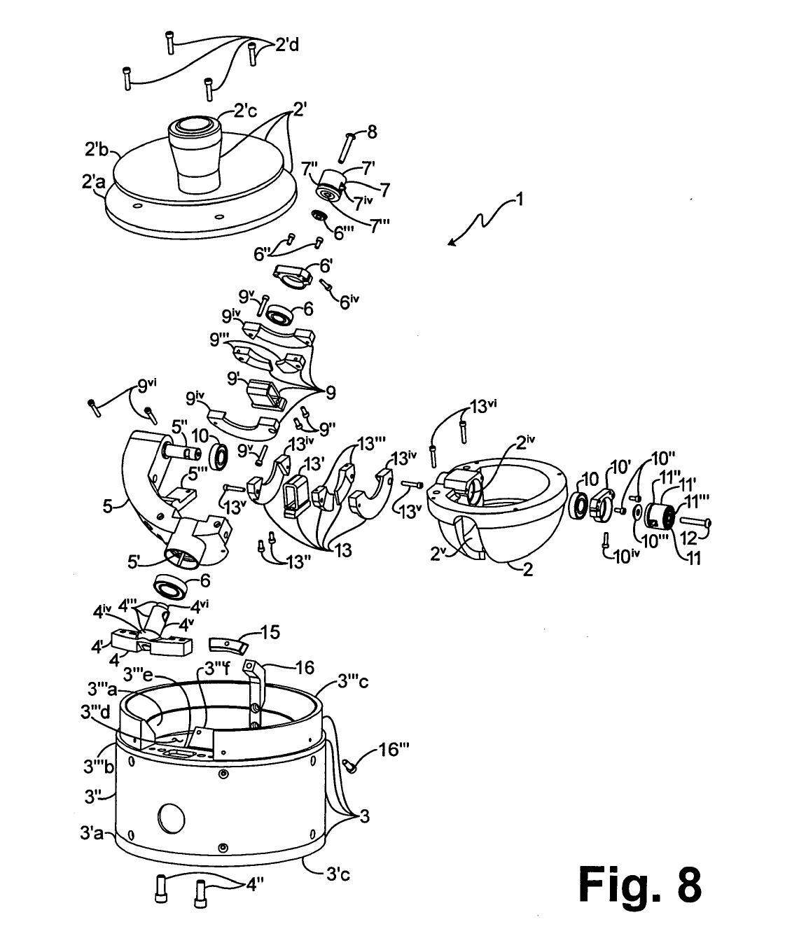

As shown in perspective views of manipulator 1 in FIGS. 1 and 2 from differing vantage points, in the bottom view thereof in FIG. 3, in the top view thereof in FIG. 4 and in the corresponding orthogonal cross section side views 5 and 6 indicated in FIG. 4, in the front elevation view of FIG. 7, and in the exploded view of FIG. 8, output structure 2 is shown to approximate a modified hemisphere, or modified hemispherical shell (so as to have an open interior). Output structure 2 has a support collar, 2″, about its generally curved side adjacent where that side perpendicularly joins to the major flat side thereof, or meets the plane of the opening thereof, this collar (and major flat side if not open) supporting at least in part workpiece object 2′. A stepped minor flat side, 2′″, of output structure 2 extends in a first portion from support collar 2″ in a direction perpendicularly away from the plane of the opening of output structure 2 (and major flat side if not open) by the omission of what would otherwise be a portion of the hemisphere or hemispherical shell of output structure 2, and in a second portion as a smaller flat side parallel to the first portion flat side by the omission of a portion of support collar 2″.

Output structure 2 has a sidewall opening, 2^{iv}, formed through a portion of support collar 2″ at stepped minor flat side 2′″, and a portion of that minor flat side, and then through an extended cylindrical opening shell that extends from the interior side of output structure 2, opposite surface minor flat side 2′″, into at least an accommodating opening in the interior of structure 2 (if the interior of that structure is not generally open). This is a double stepped opening having a pair of end interior surface portions about this opening, one at each end thereof, and each of a corresponding relatively larger end diameter so as to each be about a corresponding end space that is shaped as a truncated cylinder. This opening further has an intermediate interior surface portion thereabout of a relatively smaller intermediate diameter to be about an intermediate space also shaped as a truncated cylinder separating the two end spaces, and with these three interior surface portions all being concentric about an opening common axis.

In addition, a recessed relief channel, or as shown here, an open slot, 2^{v}, to the interior of output structure 2, is formed into, or as shown here, through, the generally curved outer surface of the hemisphere or hemispherical shell of output structure 2, extending to also be formed through the outer surface of support collar 2″, and that altogether extends from near the central point of output structure 2 farthest from the hemispherical opening thereof (and major flat side thereof if the structure interior is not open) along the side of the structure to that hemispherical opening (or major flat side). Finally, a coupling, not shown, extends through the wall of output structure 2 at this central point for passing a coolant to be used with electromagnetic radiation detectors in housing 2′c, and an electrical cabling tube, not shown, also extends through the wall of output structure 2 in which electrical power and signaling leads are to be provided as needed for the detectors in housing 2′c.

The foregoing figures further show that there is provided a base assembly, 3, with stepped approximately cylindrically shaped open centers formed by a sequence along a common axis of truncated open centers of differing cylindrical cross section diameters. Base assembly 3 is supported on a base plate, 3′, having a lower base plate ring portion, 3′a, with an exterior side surface of a greater diameter than the exterior side surface of an upper base plate ring portion, 3′b, to thereby expose a horizontal top surface of the lower base plate ring portion outside of where that ring portion is joined to the upper ring portion so as to thereby end the inward extent of surface. This horizontal top surface of lower base plate ring portion 3′a, projected parallelly inward, defines the joining plane of the upper and lower ring portions, and is positioned on the opposite side of lower base plate ring portion 3′a from a horizontal bottom surface, 3′c, of this lower base plate ring portion.

A base extender truncated cylindrical shell, 3″, has an interior shell side surface diameter approximately equal to the diameter of the exterior side surface of upper base plate ring portion 3′b, and an exterior shell side surface diameter approximately equal to the diameter of the exterior side surface of lower base plate ring portion 3′a, and is positioned on the flat top surface of this lower base plate ring portion to create a center open region above base assembly plate 3′ within the shell of this extender. Extender truncated cylindrical shell 3″ has screws, 3″a, fastening it to and about the exterior side surface of upper base plate ring portion 3′b.

Extender truncated cylindrical shell 3″ also has screws, 3″b, fastening it to a base mounting rim structure, 3′″, positioned thereon, on the end thereof opposite that on base plate 3′. Base mounting rim structure 3′″ has a lower rim ring portion, 3′″a, with an outer side surface, up to an exterior collar, 3′″b, therein that has an outer side surface diameter approximately equal to the interior shell side surface diameter of extender truncated cylindrical shell 3″. Exterior collar 3′″b has an outer side surface diameter approximately equal to the exterior shell side surface diameter of extender truncated cylindrical shell 3″ resulting in base mounting rim structure 3′″ being supported on extender truncated cylindrical shell 3″ at exterior collar 3′″b thereof.

Lower rim ring portion 3′″ a has a stepped interior with a larger interior diameter at the end thereof nearest to base plate 3′ to provide a first interior surface portion to be about a first truncated cylindrical space that is stepped to a smaller interior diameter at a location below a plane through the lower surface of exterior collar 3′″b to form a second interior surface portion to be about a second truncated cylindrical space except for the intrusion therein of a support arm to be described below. This second interior surface portion and second truncated cylindrical space extend up past a plane through the upper surface of exterior collar 3′″b parallel to the plane through the lower surface of exterior collar 3′″b. The lower rim ring portion 3′″a ends at this upper plane, and an upper rim broken ring portion, 3′″c, begins there with the second interior surface portion and second truncated cylindrical space extending past this upper plane to so as to have the second interior surface portion reach and join the remainder of the interior surface of upper rim broken ring portion 3′″c as a third interior surface portion beginning where it starts to be beveled outwardly at about 45° from a perpendicular with respect to the previously mentioned collar surfaces planes. The first and second interior surface portions and truncated cylindrical spaces are concentrically positioned about a common base axis that is also perpendicular with respect to the previously mentioned collar surfaces planes. The diameter of the outer side surface of upper rim broken ring portion 3′″c is that of the side surface of lower rim ring portion 3′″a, and the beveled interior surface of upper rim broken ring portion 3′″c stops short of reaching the outer side surface to thereby leave a top surface on upper rim broken ring portion 3′″c approximately parallel to the previously mentioned collar surfaces planes except at the location of the break in that portion.

This break, 3′″d, in upper rim broken ring portion 3′″c exposes the upper surface of an inwardly expanded portion, 3′″e, of lower rim ring portion 3′″a at the upper surface of exterior collar 3′″b therein. A base motor support arm, 3′″f, extends further inwardly from inwardly expanded portion 3′″e of lower rim ring portion 3′″a at this break location into the second truncated cylindrical space. The upper surface of base motor support arm 3′″f extends inwardly parallel to, but some short distance below, the plane through the upper surface of exterior collar 3′″b, and this upper surface of the arm then angles upward at an angle of approximately 45°. The bottom surface of base motor support arm 3′″f extends inwardly parallel to the upper surface thereof from the step in lower rim ring portion 3′″a separating the first and second interior surface portions thereof. The upwardly angled portion of base motor support arm 3′″f terminates approximately within the second truncated cylinder space.

A holder support, 4, has a base, 4′, with threaded openings therein with base 4′ extended laterally so as to match a portion of inwardly expanded portion 3′″e of lower rim ring portion 3′″a at the upper surface of exterior collar 3′″b therein, and on which the bottom of base 4′ is positioned. Holder base 4′ is affixed thereto by a pair of bolts, base, 4″, extending through inwardly expanded portion 3′″e into the threaded holes therein. A canted post, 4′″, angled upward from the plane through the upper surface of exterior collar 3′″b at an angle of approximately 45°, begins at one end thereof with an embedded ring portion, 4^{iv}, integrally formed in base 4′. The remainder of canted post 4′″ is formed of two truncated cylindrical shells including a first post truncated cylindrical shell, 4^{v}, having an outer diameter less than that of embedded ring portion 4^{iv} and with which it is integrally formed so as to be positioned concentrically with that embedded ring about a post common axis. The inner diameter of this shell is that of the inner opening in the embedded ring.

The final portion of canted post 4′″ is a second post truncated cylindrical shell, 4^{vi}, having an outer diameter less than that of first post truncated cylindrical shell 4^{v} and with which it is integrally formed so as to be positioned concentrically with the embedded ring and the first post shell about the same post common axis. The inner diameter of this second post shell is significantly less than that of the first post shell, and this interior of the second post shell is threaded from inward from the outermost end thereof. The thickness of embedded ring portion 4^{iv} along the common axis and the extent of second post shell 4^{vi} along the common axis are both significantly less than the extent of first post shell 4^{v} along the common axis. There are two openings provided through the shell wall of the first post shell 4^{v} near to where second shell post 4^{vi} joins the first with these openings being opposite one another such that an axis joining their centers is perpendicular to the common axis.

A cantilevered, curved, hollow bar structure, holder, 5, has an inner end with a holder support engagement opening, 5′, extending therethrough into which canted post 4′″ extends to result in holder 5 being supported by holder support 4. Holder support engagement opening 5′ is formed through the inner end of the bar structure of holder 5 and through an extended cylindrical opening shell that extends from the surface of the inner end of holder 5 in a direction that is outward to the curve of the bar structure and toward holder support base 4′. This is a double stepped opening having a pair of end interior surface portions about this opening, one at each end thereof, and each of a corresponding relatively larger end diameter so as to each be about a corresponding end space that is shaped as a truncated cylinder. This opening further has an intermediate interior surface portion thereabout of a relatively smaller intermediate diameter to be about an intermediate space also shaped as a truncated cylinder separating the two end spaces, and with these three interior surface portions all being concentric about an opening common axis aligned with the post common axis.

Holder 5 also has an outer end as an opposite end thereof which the curved bar structure thereof leads this outer end having a spindle axis extending therethrough that is perpendicular to the post common axis of canted post 4′″ which it intersects. A holder spindle, 5″, formed as a truncated cylinder, extends from the surface of the outer end of holder 5 that is inward to the curve of the bar structure toward the post common axis, and to which inner surface it is affixed so as to be concentric about this spindle axis. The outer end of holder spindle 5″ has a threaded opening extending inward into the spindle along the spindle axis.

Additionally, holder 5 also has a holder motor support arm, 5′″, extending from that surface of inner end of holder 5 that is inward to the curve of the bar structure and to which surface it is also affixed. The upper and lower surfaces of this arm extend along a plane parallel to a plane including the post common axis that is also perpendicular to the spindle axis. In addition, these surfaces of holder motor support arm 5′″ extend toward base 3 at an angle of approximately 45° to the post common axis if that axis was projected along the spindle axis into this parallel plane.

Finally, holder 5 also has a motor positioning sidewall plate, 5^{iv}, which is affixed to, and positioned on, the base side of the bar structure of holder 5 at the inner end thereof, across from the portion thereof forming part of the structure wall about holder support engagement opening 5′, to thus be symmetrically positioned across from, and on either side of, that opening. Motor positioning sidewall plate 5^{iv} is formed by a semicircular plate extending toward base assembly 3 perpendicularly to a plane enclosing the plane curve followed by holder 5 and both the common post axis and the spindle axis.

A pair of ball bearings, 6, is used with holder 5 about canted post 4′″ with the inner and outer members of this pair positioned in a corresponding one of the end spaces surrounded by the corresponding one of relatively larger diameter end interior surface portions of holder support engagement opening 5′ at the opposite ends of this opening. Each pair member has ring shaped races with one race side positioned against the corresponding inside shoulder formed by the relatively smaller diameter of the intermediate interior surface portion between the two end interior surface portions. The inner one of bearings pair 6 is also positioned about first post truncated cylindrical shell 4^{v} and the outer one about second post truncated cylindrical shell 4^{vi}.

Holder 5 and ball bearings pair 6 are secondarily retained about canted post 4′″ by an “eared” split ring, 6′, attached to holder 5 at the surface of the inner end thereof that is inward to the curve of its bar structure by a pair of retaining bolts, 6″. The primary purpose of “eared” split ring 6′ instead is to hold a resolver, as described below, which in turn is in the primary retaining arrangement for retaining holder 5 and ball bearings pair 6. Bolts 6″ extend through the “ears” of split ring 6′, located at the ends of a sector of the ring opening opposite the base side sector thereof, to be threaded tightly into corresponding threaded openings in holder 5 similarly positioned about the engagement opening.

A stepped spacer ring, 6′″, with an inner ring portion having a diameter to allow it to fit inside the center opening of the outer one of bearings 6, and with a concentrically integral outer ring portion having a diameter about equal that of the outer diameter of outer one of bearings pair 6, is positioned about second post truncated cylindrical shell 4^{vi}, and against the outside of the race of the outer one of bearings pair 6. Stepped spacer ring 6′″ forms a part of the primary retaining arrangement for retaining holder 5 and ball bearings pair 6. Thus, holder 5 is mounted on canted post 4′″ with the inner one of separated bearings pair 6 about first post truncated cylindrical shell 4^{v} and the outer one of bearings pair 6 about second post truncated cylindrical shell 4^{vi} to thereby allow holder 5 to rotate about canted post 4′″ while suspended across from the open center above base assembly plate 3′ surrounded by the shell of extender 3″ and base mounting rim structure 3′″.

A further bolt, 6^{iv}, extends from one side of split ring 6′ across the split gap, extending from outside this ring to the ring center opening, and further extends into a threaded opening in the ring on the opposite side of the gap so that the spit ring can be tightened about a small portion of a brushless resolver, or rotary transformer, 7, at an outer case, 7′, thereof to hold same as indicated above. Resolver 7 is a holder rotation measurement resolver and has the remaining portion thereof extending along the post common axis of canted post 4′″.

Outer case 7′ has electrical windings within it and a groove, 7″, in and around the outside of it. Case 7′ surrounds a hollow shaft, 7′″, with electrical windings about it, and with this shaft being supported by case 7′ on bearings so that shaft 7′″ can rotate with respect to case 7′. These case and rotor electrical windings are connected to external resolver electrical leads, 7^{iv}, which are for connection to a suitable voltage source and to a suitable voltage measuring instrument. These leads are positioned through an opening beginning at an end of, and extending through, motor magnet support 5^{iv} to the opening provided through the shell wall of the first post shell 4^{v}, and then through the open interior thereof and that of embedded ring portion 4^{iv}, to emerge in the interior space of base assembly 3.

Case 7′ is the part of resolver 7 that is held in split ring 6′, in the ring center opening thereof, so that resolver 7 is against the outer surface of the outer ring portion of stepped spacer ring 6′″, to thereby be positioned just outside holder support engagement opening 5′, as a further part of the primary retaining arrangement for retaining holder 5 and ball bearings pair 6. Thus, case 7′ rotates with holder 5.

In accord with above, hollow shaft 7′″ of resolver 7 is positioned against the outer surface of the outer ring portion of stepped spacer ring 6′″, and has a screw, 8, extending both within it and into the threaded interior opening extending through the end surface of second post truncated cylindrical shell 4^{vi} and so into that shell parallel to its cylindrical length. Screw 8 holds shaft 7′″ in a fixed position with respect to canted post 4′″ so that rotations of holder 5 with respect to this post also rotate case 7′ with it about shaft 7′″. Thus, screw 8 is the final part of the primary retaining arrangement for retaining holder 5 and ball bearings pair 6 holding resolver shaft 7′″ against stepped spacer ring 6′″ held in turn thereby against the nearest one of bearings 6 with a selected force determined by the distance that screw 8 is rotatably forced into second post truncated cylindrical shell 4^{vi}. Rotations of output structure 2 about the spindle axis of holder spindle 5″, to be described below, result in rotations of recessed relief channel 2^{v} past the head of screw 8 that projects into that recess. If suitable sinusoidal voltage is applied to leads 7^{iv} extending from either of the case or shaft electrical windings, voltage measurements of the remaining ones of leads 7^{iv} extending from the other electrical winding will provide voltage value representations of the angular changes between case 7′ and shaft 7′″ due to such relative rotations between them.

Rotations of holder 5 with respect to canted post 4′″, to thereby result in corresponding rotations of case 7′ about shaft 7′″ of resolver 7, are forced by a brushless sectional torque holder rotation motor, 9. Holder rotation motor 9 provides varying torque over a limited angular range using electrical currents selectively provided by a controller (not shown) in a solenoidal electrical winding in a motor stator section, 9′, formed about a rounded corner rectangular cross section tube having two spaced apart larger sides opposite one another that are joined together at two opposite edges thereof by two spaced apart smaller sides opposite one another. This tube structure is mounted on a flat plate base at one of its smaller sides. Motor stator section 9′ is mounted with its flat plate base on base motor support arm 3′″f and affixed thereto using a pair of screws, 9″, that are extend through the arm to be threaded tightly into corresponding threaded holes in that motor stator base.

Electrical current in the solenoidal winding about the tube can thereby generate corresponding magnetic fields a) within the interior of that tube through that rectangular cross section thereof, including through a pair of permanent magnets, 9′″, each shaped approximately as a quarter circle sector plate that together are rotatable in and out of the tube interior, and also b) about the exterior of that tube including through a pair of ferrous material field shaping plates, 9^{iv}, with each shaped as a semicircular sector plate positioned parallel and adjacent to a corresponding one of the larger tube sides, such that the tube is positioned between them, and which plates are rotatable past those sides. These variable generated fields, generated by the variable currents in the solenoidal winding, interact with the magnetic fields provided by permanent magnets 9′″, serving with field shaping plates 9^{iv} together as a motor rotor section, to thereby generate a corresponding torque on the rotor section.

The direction of resulting rotation is determined by the direction of electrical current provided through the electrical winding in motor stator section 9′ as connected externally by electrical leads partially shown. The leads from this winding emerge in the interior space of base assembly 3.

The pair of permanent magnets 9′″ in the motor rotor section have each member with an outward projected boss on either side of the plate forming it at the upper end thereof. Each of field shaping plates 9^{iv} in the motor rotor section have an outward projected boss on the inside of the plate forming it at each end thereof facing a corresponding boss on the corresponding one of permanent magnets 9′″. Permanent magnets 9′″ and field shaping plates 9^{iv} are joined together in a single rotatable rotor structure with the facing bosses of each against one another and affixed together using a pair of screws, 9^{v}, facing opposite directions and extending through the initially nearest field shaping plate and a magnet into a threaded opening in the farthest field shaping plate so that these magnets together have their major extents in line with one another and perpendicular to the bosses thereon. The two magnets are thereby suspended along a common plane and spaced somewhat from one another by a gap therebetween. Each of these permanent magnets, in directions toward each other and beginning past the bosses thereof, is formed of a relatively thin, curved plate following a symmetry path approximating a quarter circular sector and tapering from their bosses at the upper ends thereof to become thinner along its symmetrical path toward the gap separating them. The single rotatable rotor structure of magnets 9′″ and field shaping plates 9^{iv} joined together as the motor rotor section, are affixed to holder 5 adjacent to positioning sidewall plate 5^{iv} using a pair of screws, 9^{vi}, that extend through that holder into threaded holes in the top edges of the bosses in corresponding ones of magnets 9′″.

When assembled, each of the two permanent magnets 9′″ has the end thereof, closest to the other, positioned in the interior of the tube of motor stator section 9′ to extend through the rounded corner rectangular cross section thereof with field shaping plates 9^{iv} positioned outside of, and on either side of, that tube so that there are joined magnet and plate bosses across from, and intersected by a plane containing, a corresponding tube larger side. These magnet ends rotate through this tube cross section together with the field shaping plates rotating therewith along the outside of the corresponding one of the larger tube sides all in response to the providing of variable currents in the electrical winding in motor stator section 9′ through leads, 9^{vii}, connected thereto. As indicated above, these currents result in generated magnetic fields that interact with the magnetic fields provided by permanent magnets 9′″ to thereby force holder 5 to rotate with these magnets affixed thereto.

Output structure 2 has holder 5 positioned with respect thereto such that the spindle axis through holder spindle 5″ is aligned with the opening common axis through sidewall opening 2^{iv} of that structure to together both intersect and be perpendicular to the post common axis. That is, output structure 2 is supported on holder spindle 5″ extending through sidewall opening 2^{iv} into the extended cylindrical opening shell so that both the spindle axis and the opening common axis through sidewall opening 2^{iv}, with which it is aligned, extend through support collar 2″ perpendicularly to minor flat side 2′″ of that output structure.

A pair of ball bearings, 10, is used with output structure 2 about holder spindle 5″ with the inner and outer members of this pair positioned in a corresponding one of the end spaces surrounded by the corresponding one of relatively larger diameter end interior surface portions of sidewall opening 2^{iv} at the opposite ends of this opening. Each pair member has ring shaped races with one race side positioned against the corresponding inside shoulder formed by the relatively smaller diameter of the intermediate interior surface portion between the two end interior surface portions.

Output structure 2 and ball bearings pair 10 are secondarily retained about holder spindle 5″ by an “eared” split ring, 10′, attached to output structure 2 at the inner end of the extended cylindrical opening shell that extends from the interior side of output structure 2, opposite surface minor flat side 2′″, into at least an accommodating opening in the interior of structure 2 (if the interior of that structure is not generally open) by a pair of retaining bolts, 10″. The primary purpose of “eared” split ring 10′ instead is to hold a resolver, as described below, which in turn is in the primary retaining arrangement for retaining output structure 2 and ball bearings pair 10. Bolts 10″ extend through the “ears” of split ring 10′, located at the ends of a sector of the ring opening opposite the base side sector thereof, to be threaded tightly into corresponding threaded openings in output structure 2 similarly positioned about the sidewall opening.

A stepped spacer ring, 10′″, with an inner ring portion having a diameter to allow it to fit inside the center opening of the outer one of bearings 10, and a concentrically integral outer ring portion having a diameter about equal that of the outer diameter of the outer one of bearings pair 10 is positioned about holder spindle 5″, and against the outside of the race of the outer one of bearings pair 10. Stepped spacer ring 10′″ forms a part of the primary retaining arrangement for retaining output structure 2 and ball bearings pair 10. Thus, output structure 2 is mounted on holder spindle 5″ with inner and outer ones of separated bearings pair 10 thereabout to thereby allow output structure 2 to rotate about holder spindle 5″ while suspended across from the open center above base assembly plate 3′ surrounded by the shell of extender 3″ and base mounting rim structure 3′″.

A further bolt, 10^{iv}, extends from one side of split ring 10′ across the split gap, extending from outside this ring to the ring center opening, and further extends into a threaded opening in the ring on the opposite side of the gap so that the spit ring can be tightened about a small portion of a brushless resolver, or rotary transformer, 11, at an outer case, 11′, thereof. Resolver 11 is an output structure rotation measurement resolver and has the remaining portion thereof extending along the spindle axis of holder spindle 5″.

Outer case 11′ has electrical windings within it and a groove, 11″, in and around the outside of it. Case 11′ surrounds a hollow shaft, 11′″, with electrical windings about it, and with this shaft being supported by case 11′ on bearings so that shaft 11′″ can rotate with respect to case 11′. These case and rotor electrical windings are connected to external resolver electrical leads, 11^{iv}, which are for connection to a suitable voltage source and to a suitable voltage measuring instrument. These leads are positioned beginning through an opening very near the at the outer end of holder 5, and leading to the hollow interior thereof, and then to the opening provided through the shell wall of the first post shell 4^{v}, and again through the open interior thereof and that of embedded ring portion 4^{iv}, to emerge in the interior space of base assembly 3.

Case 11′ is the part of resolver 11 that is held in split ring 10′, in the ring center opening thereof, so that resolver 11 is against the outer surface of the outer ring portion of stepped spacer ring 10′″ to be positioned just outside the inner end of the extended cylindrical opening shell that extends from the interior side of output structure 2, opposite surface minor flat side 2′″, and in at least an accommodating opening in the interior of structure 2 (if the interior of that structure is not generally open) as a further part of the primary retaining arrangement for retaining output structure 2 and ball bearings pair 10. Thus, case 11′ rotates with output structure 2.

In accord with above, hollow shaft 11′″ is positioned against the outer surface of the outer ring portion of stepped spacer ring 10′″, and has a screw, 12, extending both within it and into the threaded interior opening extending through the end surface of the outer end of holder spindle 5″ and so into that spindle parallel to its cylindrical length. Screw 12 holds shaft 11′″ in a fixed position with respect to holder spindle 5″ so that rotations of output structure 2 with respect to this spindle also rotate case 11′ with it about shaft 11′″. Thus, screw 12 is the final part of the primary retaining arrangement for output structure 2 and ball bearings pair 10 holding resolver shaft 11′″ against stepped spacer ring 10′″ held in turn thereby against the nearest one of bearings 10 with a selected force determined by the distance that screw 12 is rotatably forced into holder spindle 5″. Again, as indicated above, rotations of output structure 2 about the spindle axis of holder spindle 5″ result in rotations of recessed relief channel 2^{v} past the head of screw 8 that projects into that recess. If suitable sinusoidal voltage is applied to leads 11^{iv} extending from either of the case or shaft electrical windings, voltage measurements of the remaining ones of leads 11^{iv} extending from the other electrical winding will provide voltage value representations of the angular changes between case 11′ and shaft 11′″ due to such relative rotations between them.

Rotations of output structure 2 with respect to holder spindle 5″, to thereby result in corresponding rotations of case 11′ about shaft 11′″ of resolver 11, are forced by a brushless sectional torque output structure rotation motor, 13. Output structure rotation motor 13 provides varying torque over a limited angular range using electrical currents selectively provided by a controller (not shown) in a solenoidal electrical winding in a motor stator section, 13′, formed about a rounded corner rectangular cross section tube having two spaced apart larger sides opposite one another that are joined together at two opposite edges thereof by two spaced apart smaller sides opposite one another. This tube structure is mounted on a flat plate base at one of its smaller sides. Motor stator section 13′ is mounted with its flat plate base on holder motor support arm 5′″ and affixed thereto using a pair of screws, 13″, that are extend through the arm to be threaded tightly into corresponding threaded holes in that motor stator base.

Electrical current in the solenoidal winding about the tube can thereby generate corresponding magnetic fields a) within the interior of that tube through that rectangular cross section thereof, including through a pair of permanent magnets, 13′″, each shaped approximately as a quarter circle sector plate that together are rotatable in and out of the tube interior, and also b) about the exterior of that tube including through a pair of ferrous material field shaping plates, 13^{iv}, with each shaped as a semicircular sector plate positioned parallel and adjacent to a corresponding one of the larger tube sides, such that the tube is positioned between them, and which plates are rotatable past those sides. These variable generated fields, generated by the variable currents in the solenoidal winding, interact with the magnetic fields provided by permanent magnets 13′″, serving with field shaping plates 13^{iv} together as a motor rotor section, to thereby generate a corresponding torque on the rotor section.

The direction of resulting rotation is determined by the direction of electrical current provided through the electrical winding in motor stator section 13′ as connected externally by electrical leads partially shown. The leads from this winding emerge in the interior space of base assembly 3.

The pair of permanent magnets 13″ in the motor rotor section each have an outward projected boss on either side of the plate forming it at the upper end thereof. Each of field shaping plates 13^{iv} in the motor rotor section have an outward projected boss on the inside of the plate forming it at each end thereof facing a corresponding boss on the corresponding one of permanent magnets 13′″. Permanent magnets 13′″ and field shaping plates 13^{iv} are joined together in a single rotatable rotor structure with the facing bosses of each against one another and affixed together using a pair of screws, 13^{v}, facing opposite directions and extending through the initially nearest field shaping plate and a magnet into a threaded opening in the farthest field shaping plate so that these magnets together have their major extents in line with one another and perpendicular to the bosses thereon. The two magnets are thereby suspended along a common plane and spaced somewhat from one another by a gap therebetween. Each of these permanent magnets, in directions toward each other and beginning past the bosses thereof, is formed of a relatively thin, curved plate following a symmetry path approximating a quarter circular sector and tapering from their bosses at the upper ends thereof to become thinner along its symmetrical path toward the gap separating them. The single rotatable rotor structure of magnets 13′″ and field shaping plates 13^{iv} joined together as the motor rotor section, are affixed to output structure 2 adjacent to minor flat side 2′″ thereof using a pair of screws, 13^{vi}, that extend through collar 2″ of output structure 2 from the upper surface thereof into threaded holes in the top edges of the bosses in corresponding ones of magnets 13′″.

When assembled, each of the two permanent magnets 13′″ has the end thereof, closest to the other, positioned in the interior of the tube of motor stator section 13′ to extend through the rounded corner rectangular cross section thereof with field shaping plates 13^{iv} positioned outside of, and on either side of, that tube so that there are joined magnet and plate bosses across from, and intersected by a plane containing, a corresponding tube larger side. These magnet ends rotate through this tube cross section together with the field shaping plates rotating therewith along the outside of the corresponding one of the larger tube sides all in response to the providing of variable currents in the electrical winding in motor stator section 13′ through leads, 13^{vii}, connected thereto. As indicated above, these currents result in generated magnetic fields that interact with the magnetic fields provided by permanent magnets 13′″ to thereby force output structure 2 to rotate with these magnets affixed thereto.

A partial support ring, 15, is positioned against the curved surface portion of output structure 2 following the structure general hemisphere shape to support that output structure against vibration and shock during use. The partial support ring is formed in the shape generally of a slice of a hemisphere resulting from cutting two separated planes through structure 2 parallel to the flat surface thereof, and having a diameter at the inner surface of the slice equal to the diameter of the portion of outer surface in the output structure that follows a hemisphere shape, but with a substantial part of that slice omitted. A separated, parallel outer surface of a greater diameter determines the thickness of the partial ring. The material, or materials forming, the partial ring are such that the inner surface exhibits low friction when output structure 2 moves across it.

Partial support ring 15 is held in position against output structure 2 by a support post, 16. Support post 16 is affixed to mounting rim structure 3′″ of base assembly 3 in a slot in lower rim ring portion 3′″ a extending parallel to the common base axis into upper rim broken ring portion 3′″c by bolts, 16′ and 16″, that are bolted tightly into corresponding threaded openings of which there are one in each of those two portions of mounting rim structure 3′′. Support post 16 is formed with an initial stem portion in the slot extending parallel to the common base axis to an inward canted stem portion having an opening therethrough. This canted strip portion is canted inward from the vertical stem portion at about a 45° cant angle. Partial support ring 15 is affixed to the inward end of the canted stem portion by a bolt, 16′″, through the hole in the canted stem that is tightly bolted into a corresponding threaded opening in the ring portion.

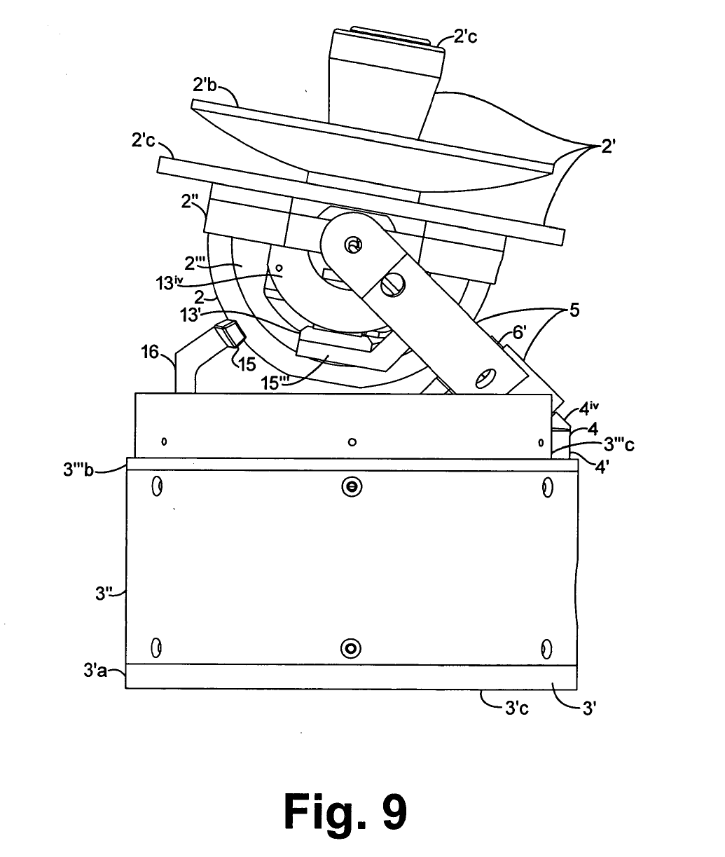

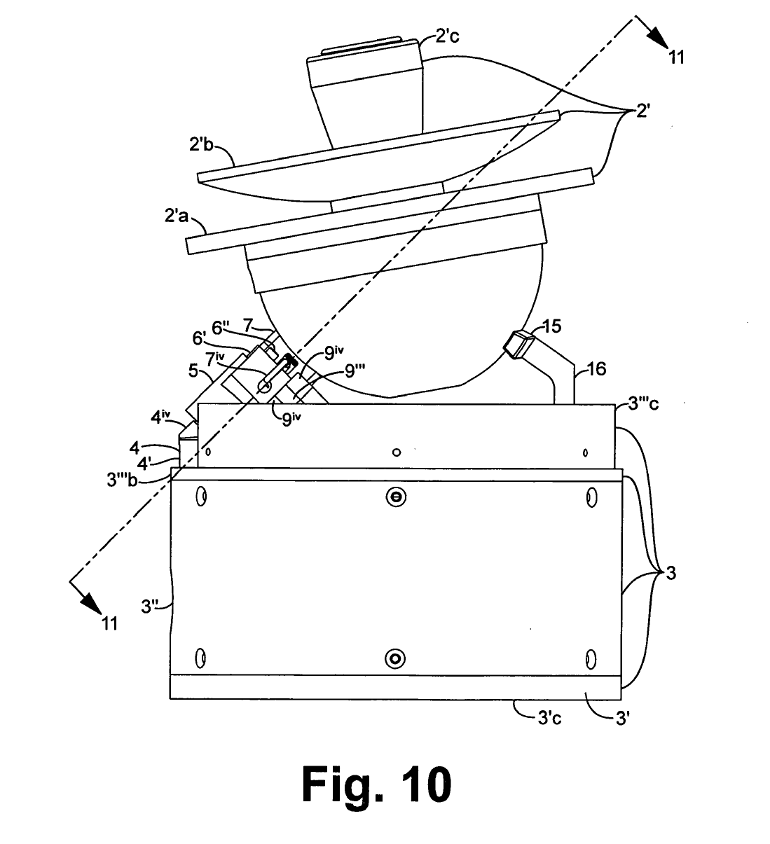

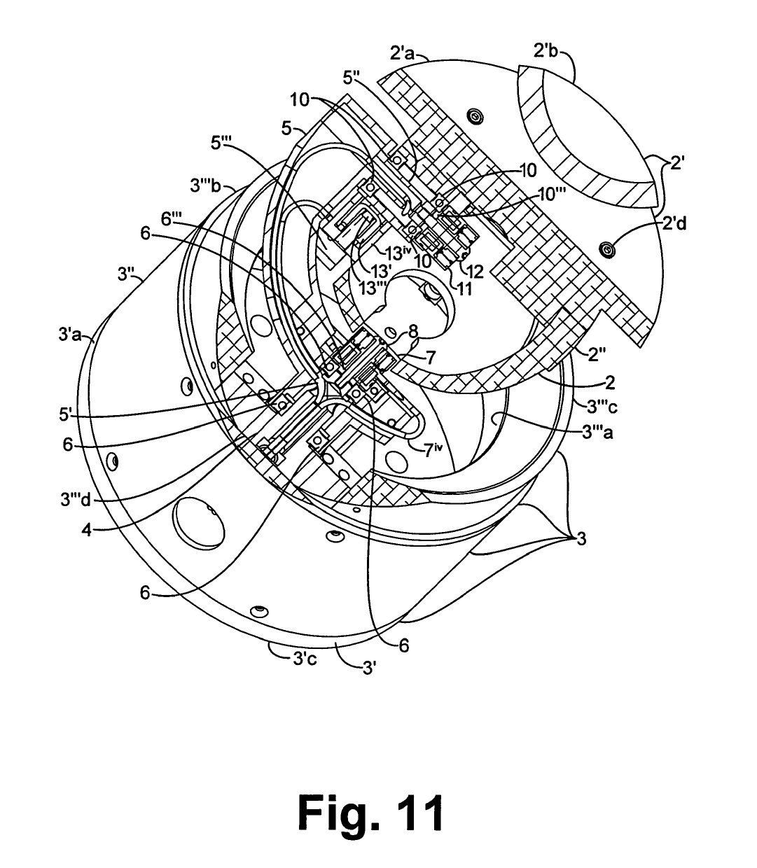

FIGS. 9 and 10 are both side elevation views of manipulator 1, but from opposite sides, and show that manipulator with workpiece object 2′ rotated somewhat from being symmetrically positioned about the common base axis toward the support for holder 5, i.e. toward holder support 4. FIG. 9 shows manipulator 1 in elevation from the side of output structure 2 at which is provided support by holder 5. FIG. 10 shows manipulator 1 in elevation from the other side of output structure 2. A cross section view of manipulator 1 is indicated in FIG. 10 to be shown in FIG. 11 that is taken along plane slanted from front to back as indicated there. This slanted cross section shown positioned in FIG. 11 so as to show both resolvers 7 and 11 in cross section in the support side perspective cross section view displayed there.

The mechanical manipulator shown in the preceding figures has holder 5 formed as cantilevered, curved, hollow bar structure having holder support engagement opening 5′ at one end rotatably fitted about canted post 4′″ and, at the other end thereof, holder spindle 5″ with output structure 2 rotatably supported thereon. Although this supporting of output structure 2 at only one location thereon reduces manipulator weight and spatial extent in that there need be only a single bar, or arm, in the holder, in some situations firmer support may be needed for satisfactory performance of the objects shown for workpiece 2′, or for satisfactory performance of different kinds of objects for workpiece 2′.

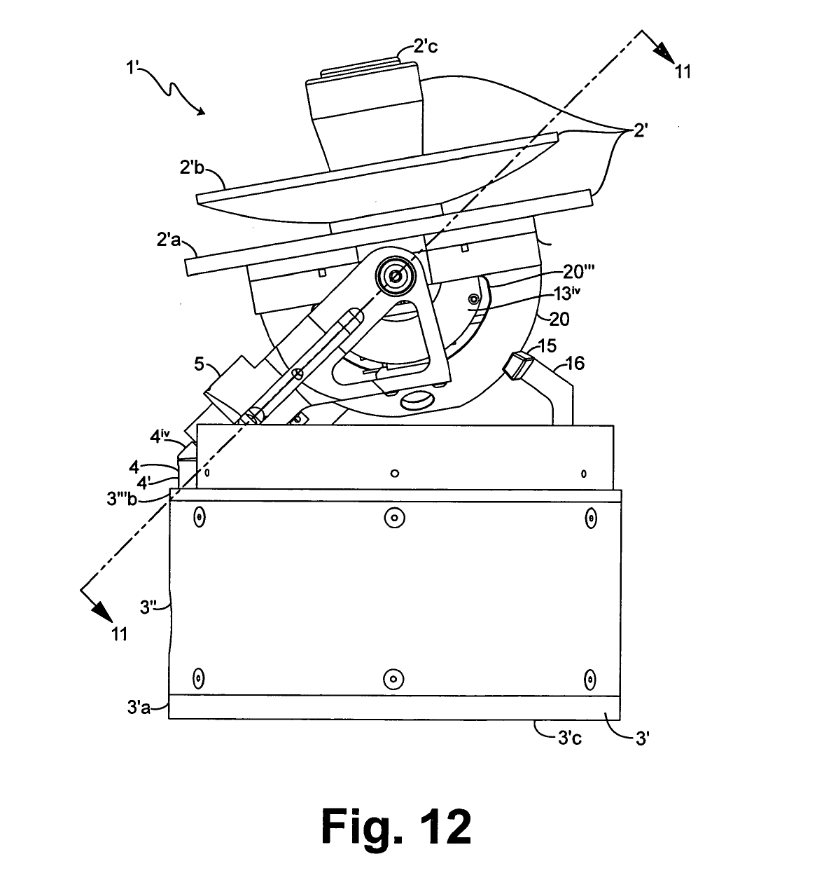

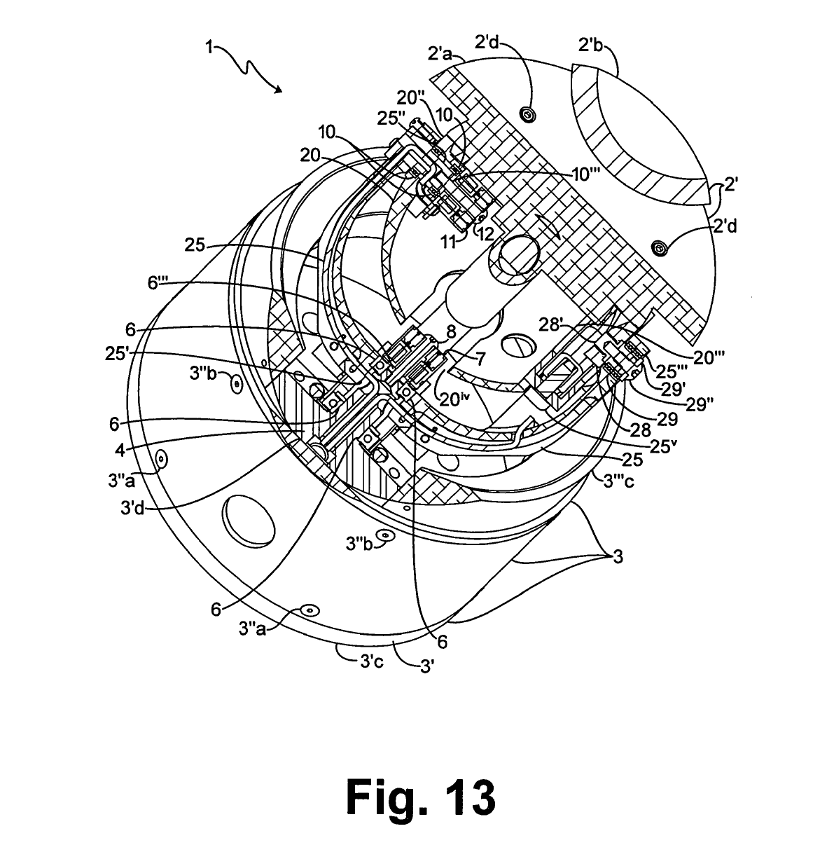

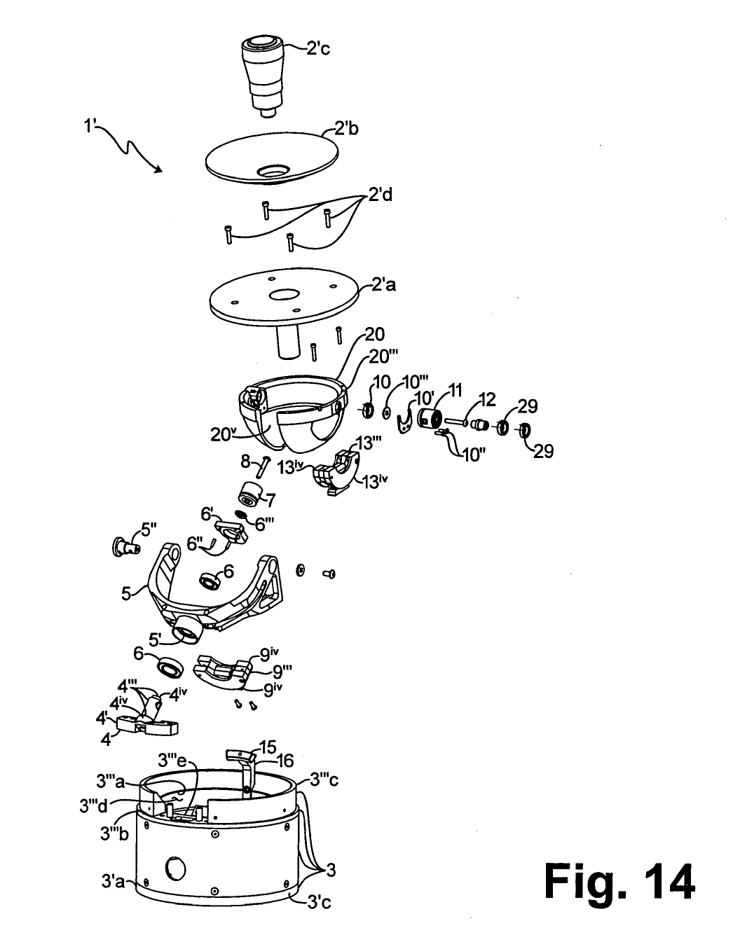

One manner of doing so involves replacing output structure 2 with a modified output structure, 20, as shown in the alternative arrangement of FIGS. 12, 13 and 14. FIG. 12 shows manipulator 1′ in elevation from the side of the output structure at which there is provided support thereto along with a motor drive therefor. A cross section view of manipulator 1′ is indicated in FIG. 12 to be shown in FIG. 13 that is taken along plane slanted from front to back as indicated there. This slanted cross section shown positioned in FIG. 13 again to show both resolvers 7 and 11 in cross section in the perspective cross section view displayed there.

Manipulator 1′ is shown again with modified output structure 20 having a support collar, 20″, about its generally curved side adjacent where that side perpendicularly joins to the major flat side thereof, or meets the plane of the opening thereof, this collar (and major flat side if not open) supporting at least in part workpiece object 2′. A minor flat side, 20′″, of output structure 20 is on the opposite side of that structure from where 2′″ occurs in output structure 2, i.e. opposite the side of output structure 20 from where the extended cylindrical opening shell that extends inwardly from the interior side thereof. Minor flat side 20′″ of output structure 20 extends perpendicularly to, but does not meet, the major flat side of that structure relatively near one edge of the major flat side by the omission of what would otherwise be a portion of the hemisphere or hemispherical shell of output structure 20 and an omission of a lower portion of support collar 20″.

Output structure 20 again has a sidewall opening, 20^{iv}, formed through a portion of support collar 20″, and then through an extended cylindrical opening shell that extends from the interior side of output structure 20, into at least an accommodating opening in the interior of structure 2 (if the interior of that structure is not generally open). This is a double stepped opening having a pair of end interior surface portions about this opening, one at each end thereof, and each of a corresponding relatively larger end diameter so as to each be about a corresponding end space that is shaped as a truncated cylinder. This opening further has an intermediate interior surface portion thereabout of a relatively smaller intermediate diameter to be about an intermediate space also shaped as a truncated cylinder separating the two end spaces, and with these three interior surface portions all being concentric about an opening common axis.

Again, a recessed relief channel, 20^{v}, or as shown here, an open slot, is formed in the generally curved surface of the hemisphere or hemispherical shell of output structure 20 and a lower portion of support collar 20″ and that altogether extends from near the central point of output structure 20 farthest from the hemispherical opening thereof (and major flat side thereof if the structure interior is not open) along the side of the structure to that hemispherical opening (or major flat side). Finally, a coupling, not shown, extends through the wall of output structure 20 at this central point for passing a coolant to be used with electromagnetic radiation detectors in housing 2′c, and an electrical cabling tube, not shown, also extends through the wall of output structure 20 in which electrical power and signaling leads are to be provided as needed for the detectors in housing 2′c.

In addition to providing a modified output structure 20 in this alternative arrangement, holder 5 is also replaced with a two arm fork arc structure, 25, again as shown in FIGS. 12 and 13. However, holder support engagement opening 5′″ in holder 5 is retained as a fork arc structure support engagement opening, 25′, in fork arc structure 25. Canted post 4′″ extends through engagement opening 25′ to result in fork arc structure 25 being rotatably mounted on holder support 4 about canted post 4′″ all supported on base assembly 3.

Fork arc structure 25 is secured to holder support 4, just as holder 5 was, with structure 25 and ball bearings pair 6 being secondarily retained about canted post 4′″ by “eared” split ring 6′, attached to arc structure 25 at the surface of the middle fork portion thereof that is inward to the curve of its fork structure by retaining bolts pair 6″ threaded into the arc structure. Stepped spacer ring 6′″ is again positioned about second post truncated cylindrical shell 4′, and against the outside of the race of the outer one of bearings pair 6. Arc structure 25 is thereby mounted on canted post 4′″ with the inner one of bearings pair 6 being about first post truncated cylindrical shell 4^{v} and the separated outer one of bearings pair 6 being about second post truncated cylindrical shell 4^{vi} to thereby allow arc structure 25 to rotate about canted post 4′″ while suspended across from the open center above base assembly plate 3′ surrounded by the shell of extender 3″ and base mounting rim structure 3′″.

Hollow shaft 7′″ of resolver 7 is again positioned against the outer surface of the outer ring portion of stepped spacer ring 6′″, and has screw 8 extending both within it and into the threaded interior opening extending through the end surface of second post truncated cylindrical shell 4^{vi} and so into that shell parallel to its cylindrical length. Screw 8 again holds shaft 7′″ in a fixed position with respect to canted post 4′″ so that rotations of arc structure 25 with respect to this post also rotate case 7′ with it about shaft 7′″.

Rotations of arc structure 25 with respect to canted post 4′″, to thereby result in corresponding rotations of case 7′ about shaft 7′″ of resolver 7, are again forced by brushless sectional torque holder rotation motor 9. Motor stator section 9′ is again mounted with its flat plate base on base motor support arm 3′″f, and field shaping plates 9′″ with magnets 9″ between them of the motor rotor section are affixed to arc structure 25 adjacent to a positioning sidewall plate as described below.

Output structure 20 is held between the two ends of the arc across from each other in arc structure 25 with the fork end corresponding to the outer end of holder 5 having a spindle, 25″, extending therefrom just as holder spindle 5″ extended from the outer end of holder 5. The outer end of arc structure spindle 25″ has a threaded opening extending inward into the spindle along the spindle symmetry axis perpendicular to this end of arc structure 25. The opposite one of the two arc structure ends has a circular output structure engagement opening, 25′″, extending through this end thereof with an axis of symmetry common to the spindle axis.

As before, arc structure 25 also has a motor positioning sidewall plate, 25^{iv}, that is affixed to, and positioned on, the base side of the arc structure of fork arc structure 25 at the middle thereof, across from the portion thereof forming part of the structure wall about arc structure support engagement opening 25′, to thus be symmetrically positioned across from, and on either side of, that opening. Motor positioning sidewall plate 25^{iv} is again a semicircular plate extending toward base assembly 3 perpendicularly to a plane enclosing the plane curve followed by the arc structure in fork arc structure 25 just as plate 5^{iv}. The ferrous metal field directing plates and magnets 9″ of the motor rotor section between them are positioned adjacent to a major side of plate 25^{iv}.

Arc structure 25 again has an arc structure motor support arm, 25^{v}, extending inward in that arc structure from the arm thereof having the end with output structure engagement opening 25′″ therein rather than the arm having the spindle as in holder 5. This shelf tab is located in that arm about midway between output structure engagement opening 25′″ and fork base engagement opening 25′ of fork arc structure 25, and again on the side of the arc structure that is inward to the curve of that structure and to which side surface it is also affixed as was holder motor support arm 5′″ in holder 5.

Output structure 20 and resolver 11 are supported on arc structure spindle 25″ much as they were on holder spindle 5″ with arc structure spindle 25″ extending through sidewall opening 20^{iv}. That is, output structure 20 is supported on arc structure spindle 25″ so that both the spindle axis and the opening common axis through sidewall opening 20^{iv}, with which it is aligned, extend through support collar 20″ perpendicularly to an axis tangent to the surface of that collar at that location.

Thus, output structure 20 is secured to arc structure 25 at the inner end of the extended cylindrical opening shell by resolver 11 being fastened there to the spindle. This extended cylindrical opening shell extends from the interior side of output structure 20, on the side thereof from which sidewall opening 20^{iv} opens into that shell (the side of output structure 20 opposite that at which minor flat side 20′″ is located), and into at least an accommodating opening in the interior of structure 20 (if the interior of that structure is not generally open), just as it was to holder 5. Output structure 20 and ball bearings pair 10 are secondarily retained about output structure spindle 25″ by “eared” split ring 10′, attached to output structure 20 at the inner cylindrical end by retaining bolts pair 10″ threaded into this cylindrical end. Stepped spacer ring 10′″ is again positioned about output structure spindle 25″, and against the outside of the race of the outer one of bearings pair 10. Output structure 20 is thereby mounted on arc structure spindle 25″ with inner and outer ones of separated bearings pair 10 thereabout to thereby allow output structure 20 to rotate about arc structure spindle 25″ while suspended across from the open center above base assembly plate 3′ surrounded by the shell of extender 3″ and base mounting rim structure 3′″.

Hollow shaft 11′″ of resolver 11 is again positioned against the outer surface of the outer ring portion of stepped spacer ring 10′″, and has screw 12 extending both within it and into the threaded interior opening extending through the end surface of arc structure spindle 25″ and so into that shell parallel to its cylindrical length. Screw 12 again holds shaft 11′″ in a fixed position with respect to arc structure spindle 25″ so that rotations of output structure 20 with respect to this spindle also rotate case 11′ with it about shaft 11′″.

Rotations of output structure 20 with respect to fork arc structure 25 are supported on the opposite side of this output structure by the other arm of fork arc structure 25 having output structure engagement opening 25′″ extending through it. An arc structure rotary support trunnion, 28, has a threaded stub, 28′, that is screwed into a threaded opening that extends through support collar 20″ and into the remainder of output structure 20 along the common axis of symmetry of output structure spindle output structure 25′″ and engagement opening and 25′″. Trunnion 28 is further formed of a stack of two concentric truncated cylindrical shells, each of differing outer diameters, that are joined end-to-end about an axis of symmetry. One of the truncated cylindrical shells at one end of the stack, the one having the largest outer diameter, forms a base, 28″, and also forms a shoulder with respect to an outer truncated cylindrical shell, 28′″, because of having a smaller outer diameter for its outer surface that is a roller bearing support surface. Outermost truncated cylinder 28′″ extends from the outer side of the shoulder formed by truncated cylinder base 28″ to an outer end of trunnion 28 and has an end surface that extends perpendicular to the cylindrical length of this trunnion. A threaded opening extends into outermost truncated cylindrical shell 28′″ through the end surface thereof.

Output structure engagement opening 25′″, at the end of the remaining arm of fork arc structure 25, has a small diameter opening portion of a relatively small diameter extending for a short distance from the inside of the arc structure toward the outside. Thereafter, a large diameter opening portion of a relatively large diameter extends for the remaining distance toward the outside to thereby form a shoulder with respect to the small diameter opening portion.

A pair of ball bearings, 29, are positioned in the large diameter portion of output structure engagement opening 25′″ with the inside one thereof against the shoulder in that opening. Arc structure 25 is mounted on trunnion 28 such that ball bearing 29 is about the bearing surface of outermost truncated cylindrical shell 28′″ of that trunnion to thereby allow fork arc structure 25 to rotate about trunnion 28. A bearing retainer ring, 29′, is positioned against the outside bearing 29 and the end surface of outermost truncated cylindrical shell 28′″, and a retaining screw, 29″, is screwed through it into the threaded opening extending from that surface into shell 28′″.

Rotations of output structure 20 with respect to arc structure spindle 25″, to thereby result in corresponding rotations of case 11′ about shaft 11′″ of resolver 11, are again forced by brushless sectional torque holder rotation motor 13. Motor stator section 13′ is again mounted with its flat plate base on arc structure motor support arm 25^{v}, although at the arm of the arc structure with output structure engagement opening 25′″ rather than the arm with arc structure spindle 25″. The ferrous metal field directing plates 13′″ and magnets 13″ of the motor rotor section between them are together affixed to output structure 20 positioned adjacent to minor flat side 20′″ thereof.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A mechanical manipulator (1) comprising:
an output structure (2, 20) positionable by the mechanical manipulator (1);
a base assembly (3);
a holder base (4) attached to the base assembly (3);
a holder (5, 25) attached to the holder base (4), the holder (5, 25) being rotatable by a holder rotation motor (9);
a first resolver (7) mounted to measure rotational movement of the holder (5, 25);
an output structure rotation motor (13) configured to rotate the output structure (2, 20); and
a second resolver (11) mounted to measure rotational movement of the output structure (2, 20).

2. The mechanical manipulator of claim 1, wherein the output structure (2, 20) carries a workpiece object comprising at least one sensor.

3. The mechanical manipulator of claim 1, wherein the output structure (2, 20) is configured as a modified hemisphere or a modified hemispherical shell.

4. The mechanical manipulator of claim 1, wherein the holder (5) is configured as a cantilevered, curved, hollow bar structure having a holder spindle (5″) rotatably supporting the output structure (2) at a single location.

5. The mechanical manipulator of claim 1, wherein the holder (25) is configured as a two arm fork arc structure supporting the output structure (20) between two ends of the arc structure across from each other.

6. The mechanical manipulator of claim 1, further comprising a partial support ring (15) mounted on the base assembly (3) and supporting the output structure (2, 20).

7. The mechanical manipulator of claim 1, wherein the holder rotation motor (9) is configured to rotate the holder (5, 25) about a first axis, and the output structure rotation motor (13) is configured to rotate the output structure (2, 20) about a second axis.
